(19) United States
(12) Patent Application Publication
(10) Pub. No.: US 2004/0260754 A1
(43) Pub. Date: Dec. 23, 2004

(54) Systems and methods for mitigating cross-site scripting

(76) Inventors: Erik Olson, Sammamish, WA (US); David S. Ebbo, Redmond, WA (US); Susan Warren, Carnation, WA (US); Nikhil Kothari, Sammamish, WA (US); Scott Guthrie, Bellevue, WA (US); Peixin Han, Redmond, WA (US); Dmitry Robsman, Bellevue, WA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 10/600,683

(22) Filed: Jun. 20, 2003

(51) Int. Cl. G06F 15/16

(52) U.S. Cl. 709/200

(57) ABSTRACT

Systems and methods for mitigating cross-site scripting attacks. When an HTTP request is received from a user computer, the HTTP request is evaluated to determine if it includes a script construct. Particularly, data derived from an outside source that is included in the HTTP request is examined for the presence of script constructs. The presence of a script construct indicates that a cross-site scripting attack is being executed and the server computer is able to prevent the attack from being carried out.

### BACKGROUND OF THE INVENTION

1. The Field of the Invention

The present invention relates to systems and methods for protecting servers and clients from attacks. More particularly, the present invention relates to systems and methods for mitigating cross-site scripting attacks in web applications.

2. Background and Relevant Art

The Internet is a network that provides access to significant resources and activities. When a user visits different web sites over the Internet, information is exchanged between the user and the various web sites. Some of the information (account numbers, user names, passwords, personal information, etc.) exchanged between a user and a web site is more confidential than other information. In fact, some of the information is necessary in order to perform certain activities. In addition, the information exchanged between a user and a web site is often stored on the user computer.

Web-servers as well as user computers have various security concerns and the exchange of information between a user computer and a web site is one or the reasons that security is required to protect the information. One of the more common security concerns is cross-site scripting. Cross-site scripting attacks typically occur in scenarios where a server generates a dynamic web page. By creating a dynamic web page, the server may relinquish control over how the output is interpreted by the user computer. In a cross-site scripting attack, a security issue arises if untrusted dynamic content can be introduced into a dynamic page.

A cross-site scripting attack occurs, for example when an attacker creates an HTTP request that echoes back unencoded or unescaped client script provided by the attacker. The user computer then executes the script in the security context of the origin web server. This may permit the attacker to steal, for example, authentication tokens and private information. A cross-site cross scripting attack may also permit an attacker to run commands with privilege on the user computer being attacked.

On the Internet, many web-servers are unknowingly vulnerable to cross-site scripting attacks. Even though cross-site scripting attacks can be practically eliminated by rigorously validating and encoding data, many developers do not have the experience or knowledge to do this effectively. In addition, an approach that encodes all output has an impact on performance and may destroy data by encoding previously encoded data. There is a need for systems and methods that mitigating cross-site scripting attacks.

### BRIEF SUMMARY OF THE INVENTION

These and other limitations are overcome by the present invention, which relates to systems and methods for mitigating cross-site scripting attacks. Cross-site scripting is a server-side weakness that is realized when user input is rendered as HTML containing active script. When a client computer processes the response from the server, the client/user browser executes the script. Compromised user data is one result of cross-site scripting.

The present invention mitigates cross-site scripting attacks by evaluating HTTP requests at the server before dynamic rendering of the response is performed. In one embodiment, this is done by examining the HTTP request for script constructs that may indicate a cross-site scripting attack. If a script construct is discovered, then the server computer can abort the HTTP request before the cross-site scripting attack can be completed. The server, for example, can generate an error instead of serving the HTTP request, generate an error event, and the like.

Typically, the server computer only needs to examine the portions of the HTTP request that may contain data derived from outside input. The portions of the HTTP request at risk are examined for the presence of script constructs. In addition to searching for script constructs or indicators such as angle brackets, the present invention also searches for other script constructs that are only harmful when rendered inside of particular HTML elements. Elements that could be used in a cross-site scripting attack include, but are not limited to, events, expressions, and the like.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention cam be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram that illustrates one example of a cross-site scripting attack;

FIG. 2 illustrates a block diagram of a server computer that examines HTTP requests from user computers; and

FIG. 3 illustrates examples of the data in an HTTP request that may contain script constructs.

### DETAILED DESCRIPTION OF THE PREFERRED EMBODIMENTS

The present invention relates to systems and methods for mitigating a cross-site scripting attack. Today, cross-site scripting attacks may permit attackers to access authentication tokens, access confidential information, execute client script in the security context of an origin web server, run commands with privilege on a user computer, and the like. Cross-site scripting attacks are prevalent and servers that are developed by inexperienced or careless developers are particularly susceptible to cross-site scripting attacks. Web servers that are susceptible to cross-site scripting attacks place the data of their users at risk.

The present invention helps reduce the risk of cross-site scripting attacks by examining incoming HTTP requests for potential script constructs that may indicate a cross-site scripting attack. In one embodiment, the present invention examines or evaluates portions of an HTTP request that may contain data derived from outside input. If a script construct is found in the HTTP request, then the HTTP request may be terminated or prevented from causing harm.

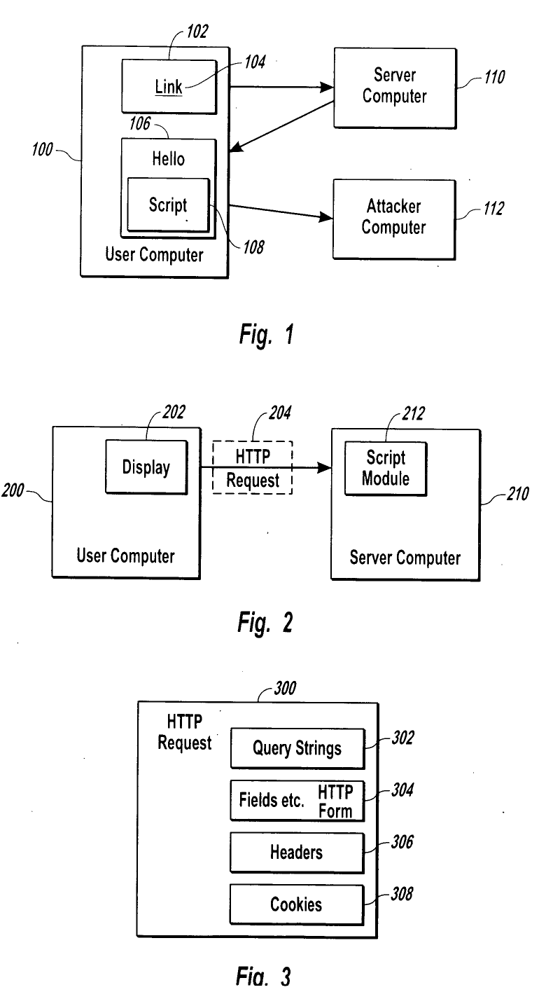

FIG. 1 illustrates one example of a server computer 110 that is vulnerable to a cross-site scripting attack. This example of a cross-site scripting attack begins after an attacker computer 112 has sent an electronic message 102 to the user computer 100. The electronic message 102 includes an embedded link 104. The embedded link 104 typically includes a script. When the user clicks on the link 104, the script may be echoed back to the user computer 100 as HTML. In other words, the request sent to the server computer 110 causes the server computer 110 to send a script 108 back to the user computer 100. The user computer 100 executes the script 108 and sends, for example, sensitive information to the attacker computer 112.

A cross-site scripting attack typically occurs in a network environment where the server computer, the user computer, and the attacker computer are in communication over a network such as the Internet, a wide area network a local area network, and the like. In the example of FIG. 1, the user computer 100, the server computer 110, and the attacker computer 112 are each connected with the Internet.

For instance, assume that a Stock Info Corporation maintains a web site that permits a user to track the user's stock prices. When the user logs into the web site, the server generates a dynamic web page that welcomes the user by name. The stock prices of the user are stored in a database and the credentials needed to access the database may be stored in a cookie on the user's computer.

In the context of FIG. 1, an attacker may send an electronic message to the user that includes a link. The text of the link may be, for example, www.mystocks.com/default.asp?name=<script>alert(‘Hello’)</script>. When the user selects this link, the user is trying to tell the server that the user's name is <script>alert(‘Hello’)</script>. The web site would ordinarily display “Hello ‘Name’” to the user. In this case, however, the web site may display “Hello” and run active content during rendering of the response.

In other words, the server generates a web page that contains the script of the attacker and serves that web page to the user computer. The user computer, however, recognizes and executes the script as if it came from a trusted source. The script may instruct the user computer to provide a cookie, which stores the user's stock information, to the attacker computer. The script, of course, can perform other activities as well.

Cross site scripting attacks can be prevented or mitigated by examining the HTTP request for active content. Active content includes, by way of example and not limitation, scripts, expressions, events, object tags, and the like. The HTTP request is examined by search for markers such as script constructs or other markers of active content.

For example, when a user is browsing the Internet, server computers generate web pages that are served to the client computer. Some of the content of the web page is prepared in response to requests from the client computer. Often, a web page will contain both text and Hyper Text Markup Language (HTML) markup. In order to distinguish between the text and the HTML markup, there are special character or character combinations that are interpreted in special ways. A “<script>” tag, for example, introduces a script for a particular scripting language. In this context, the script construct may be “<script*”. By searching the user input or user request for this particular script construct, a cross site scripting attack can be prevented. In this embodiment, the present invention searches the user input or the user request for script constructs or other markers of active content.

The following discussion illustrates examples of various markers that may indicate a cross site scripting attack. One of skill in the art can appreciate that the present invention can be used to search a request for markers or script constructs in different scripting languages and that the script constructs for a particular scripting language may be different from the script constructs of another scripting language. The markers including script constructs described herein are by way of example and not limitation.

When a request is received, the request is search for markers of active content. A server computer, for example, may maintain a list of markers of active content. The markers of active content in the list can be updated as needed or augmented with additional markers of active content. Existing markers of active content can also be deleted or made inactive. In other words, the ability of a server to recognize a cross-site scripting attack can be enhanced over time by refining the list.

FIG. 2 is an illustration of one embodiment of the present invention that reduces or mitigates the risk of cross-site scripting attacks. This example is illustrated using HTTP, but one of skill in the art can appreciate that the present invention can be implemented in other protocols. This example also illustrates a search for script constructs, which are a type of marker of active content. In FIG. 2, the user computer 200 sends an HTTP request 204 to a server computer 210. A script module 212 of the server computer 210 examines the HTTP request 204 for script constructs. If the script module 212 discovers script constructs in the HTTP request 204, then the server computer 210 can refuse to execute the HTTP request. Alternatively, the server computer 210 can also inform the user computer that a script construct has been discovered in the HTTP request 204 and ask that the user resubmit the HTTP request.

FIG. 3 illustrates an example of potential HTTP requests that may be sent by a user computer to a server computer. The HTTP request 300 may include, but is not limited to, query strings 302, fields of an HTTP form 304, headers, 306, and cookies 308. The server computer examines or evaluates all areas where user input is introduced. Form variables, query string variables, URLs with key value pairs, headers, and the like are examples of areas in an HTTP request were user input may be introduced. From the perspective of the server computer 210, the user input is one example of data that is derived from an outside source.

These HTTP requests are evaluated by the server computer 210 to determine if a script construct or other marker of active content is present in the HTTP requests. If a script construct or other marker is found, then the HTTP request is typically aborted in a safe way. An error event may be triggered that can be handled by an application or logged for administrative review.

For example, a query string 300 may have the form NAME1=VAL1 & NAME2=VAL2. The user input in this example is data at risk for the injection of a script. The data at risk in this example is “VAL1” and “VAL2.” The server computer may only examine the data at risk for script constructs in one embodiment. In such an embodiment, for example, in a query string, the server computer may only need to examine the data provided by the user.

In one embodiment, this is performed by searching for markers that match a particular pattern. The present invention not only searches for typical script constructs such as angle brackets, but also for script constructs or markers of active content that are only harmful when rendered inside of particular HTML elements. For example, the server computer may examine an HTTP request to find a “<” symbol followed by an A to Z character (“<[A . . . Z] . . . ”). Another script construct is a “<” symbol followed by a “!” symbol (“<!”). The server computer also examines the HTTP request for “&#”. This example can inject script using ascii characters.

Another type of script construct is related to events such as “onclick”. The server attempts to match a pattern that may represent a script. The server, for example, may search for “on[a . . . z]*=”. This can detect a script when the script is injected as an event to a type. Another type of script construct occurs when a script is used as the value of a tag attribute. For instance, a script can be used as an anchor in a href attribute. This is detected by examining the HTTP request for “*script:”.

A script can also be injected using expressions. For instance, in an HTML page, a tag or button may include an expression that calculates the size of the element based on something else. This may be implemented using an expression by stating, for example, “width:expression”. A script can be injected in the expression. In many cases, the expression is already implemented as a script. The danger to users exists when the script is coming to the server computer as user input. The user has no guarantee about what actions are performed by the script.

The present invention extends to both methods and systems for mitigating cross-site scripting attacks. The embodiments of the present invention may comprise a special purpose or general-purpose computer including various computer hardware, as discussed in greater detail below. The computer discussed below can be, for example, a server computer or a client computer.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a system that includes a user computer that communicates with a server computer over a network, a method for mitigating a cross-site scripting attack, the method comprising:
receiving a request from a user computer, wherein the request includes data derived from an outside source;
determining if the request from the user computer includes a marker of active content; and
refraining from executing the request if the request includes the marker of active content.

2. A method as defined in claim 1, wherein receiving a request from a user computer further comprises receiving an HTTP request from the user computer.

3. A method as defined in claim 1, wherein receiving a request from a user computer further comprises at least one of:
receiving a cookie from the user computer;
receiving a query string from the user computer;
receiving an HTTP form from the user computer; and
receiving one or more HTTP headers from the user computer.

4. A method as defined in claim 3, wherein determining if the request from the user computer includes a marker of active content further comprises evaluating only a portion of the request that includes the data derived from an outside source.

5. A method as defined in claim 1, wherein determining if the request from the user computer includes a marker of active content further comprises at least one of:
searching the request for one or more character combinations that correspond to a script construct;
searching the request for an event that includes a script construct; and
searching the request for an expression that includes a script construct.

6. A method as defined in claim 1, wherein determining if the request from the user computer includes a marker of active content further comprises searching the request for a pattern that indicates an unauthorized script.

7. A method as defined in claim 1, wherein refraining from executing the request if the request includes the marker of active content further comprises at least one of:
generating an event that is logged at the server;
encoding a response that is delivered to the user computer; and
requiring the user computer to re-submit the request.

8. In a system that includes a user computer that communicates with a server computer over a network, wherein the server computer generates dynamic content based on input from the user computer, a method for mitigating a cross-site scripting attack such that data submitted to the server computer is not sent back to the user computer as script, the method comprising:
receiving an HTTP request at a server computer, wherein the HTTP request includes input data that was not generated by the server computer;
evaluating the HTTP request to determine if the input data includes a script construct, wherein the script construct indicates that HTTP request is part of a cross-site scripting attack; and
preventing the cross-site scripting attack if the input data includes a script construct.

9. A method as defined in claim 8, wherein receiving an HTTP request at a server computer further comprises at least one of:
receiving a query string that includes at least one query string variable;
receiving a cookie;
receiving one or more headers in the HTTP request; and
receiving one or more form fields.

10. A method as defined in claim 8, wherein evaluating the HTTP request to determine if the input data includes a script construct further comprises at least one of:
searching the HTTP request for one or more character combinations that correspond to a script construct;
searching the HTTP request for an event that includes a script construct;
searching server variables that derive input data from another source; and
searching the HTTP request for an expression that includes a script construct.

11. A method as defined in claim 8, wherein evaluating the HTTP request to determine if the input data includes a script construct further comprises searching the input data for a script construct.

12. A method as defined in claim 11, wherein searching the input data for a script construct further comprises searching for patterns associated with scripts.

13. A method as defined in claim 8, wherein preventing the cross-site scripting attack if the input data includes a script construct further comprises refraining from executing the HTTP request.

14. A method as defined in claim 8, wherein preventing the cross-site scripting attack if the input data includes a script construct further comprises logging an event at the server computer.

15. A method as defined in claim 8, wherein preventing the cross-site scripting attack if the input data includes a script construct further comprises encoding the user input including the script construct to render the script inert.

16. A method as defined in claim 8, wherein evaluating the HTTP request to determine if the input data includes a script construct further comprises evaluating the HTTP request to determine in the input data includes a marker of active content.

17. A method as defined in claim 16, wherein evaluating the HTTP request to determine in the input data includes a marker of active content further comprises determining if the marker of active content is within a particular element, wherein the marker of active content is harmful only when rendered within the particular element.

18. In a system that includes a user computer that communicates with a server computer over a network, wherein the server computer generates dynamic content based on input from the user computer, a computer program product for implementing a method for mitigating a cross-site scripting attack such that input data submitted to the server computer is not sent back to the user computer as script, the computer program product comprising:
a computer-readable medium having computer executable instructions for performing the method, the method comprising:
receiving an HTTP request at a server computer, wherein the HTTP request includes input data that was not generated by the server computer;
evaluating the HTTP request to determine if the input data includes a script construct that indicates a cross-site scripting attack; and
preventing the cross-site scripting attack if the input data includes a script construct.

19. A computer program product as defined in claim 18, wherein receiving an HTTP request at a server computer further comprises at least one of:
receiving a query string that includes query string variables;
receiving a cookie;
receiving one or more headers in the HTTP request; and
receiving one or more form fields.

20. A computer program product as defined in claim 18, wherein evaluating the HTTP request to determine if the input data includes a script construct further comprises at least one of:
searching the HTTP request for one or more character combinations that correspond to a script construct;
searching the HTTP request for an event that includes a script construct;
searching server variables that derive input data from another source; and
searching the HTTP request for an expression that includes a script construct.

21. A computer program product as defined in claim 18, wherein evaluating the HTTP request to determine if the input data includes a script construct further comprises searching the input data for a script construct.

22. A computer program product as defined in claim 21, wherein searching the input data for a script construct further comprises searching for patterns associated with scripts.

23. A computer program product as defined in claim 18, wherein preventing the cross-site scripting attack if the input data includes a script construct further comprises refraining from executing the HTTP request.

24. A computer program product as defined in claim 18, wherein preventing the cross-site scripting attack if the input data includes a script construct further comprises logging an event at the server computer.

25. A computer program product as defined in claim 18, wherein preventing the cross-site scripting attack if the input data includes a script construct further comprises encoding the user input including the script construct to render the script inert.
